(19) United States
(12) Patent Application Publication
(10) Pub. No.: US 2025/0277733 A1
(43) Pub. Date: Sep. 4, 2025

(54) Accelerated Deterioration Test Apparatus, Accelerated-Deterioration-Test Analysis System, and Accelerated Deterioration Test Method

(71) Applicant: SHIMADZU CORPORATION, Kyoto-shi (JP)

(72) Inventors: Yukinori HASEGAWA, Kyoto-shi (JP); Kenichi KITAMURA, Kyoto-shi (JP); Masaru FURUTA, Kyoto-shi (JP); Ryutaro ODA, Kyoto-shi (JP)

(21) Appl. No.: 18/858,979

(22) PCT Filed: Jun. 12, 2023
(86) PCT No.: PCT/JP2023/021697

§ 371 Date: Oct. 22, 2024

(30) Foreign Application Priority Data
Jun. 27, 2022 (JP) 2022-102625

(51) Int. Cl. G01N 17/00

(52) U.S. Cl. CPC G01N 17/004

(57) ABSTRACT

An accelerated deterioration test apparatus (101) according to this invention includes a container (10) configured to be able to accommodate a sample (200) as a subject of an accelerated deterioration test for accelerating deterioration of the sample (200) as the test subject by using a deterioration factor for deteriorating the sample; and an introducer/collector (120) connected to the container (10) to introduce a gas or a liquid as the deterioration factor into the container (10) and to collect, during the accelerated deterioration test, a product that appears with the deterioration of the sample (200).

### TECHNICAL FIELD

The present invention relates to an accelerated deterioration test apparatus, an accelerated-deterioration-test analysis system, and an accelerated deterioration test method.

### BACKGROUND ART

Combination cycle testers are known for evaluating corrosion resistances of various types of materials by applying tests to various types of materials under a plurality of combined types of test conditions (environmental tests) in the art. Such an apparatus is disclosed in Japanese Patent Laid-Open Publication No. JP 2018-132385, for example.

In the combination cycle tester in the aforementioned Japanese Patent Laid-Open Publication No. JP 2018-132385, an accelerated deterioration test for accelerating deterioration of various types of materials is conducted in a test chamber while adjusting deterioration factors (deterioration loads) such as temperature and humidity. This combined cycle tester introduces outside air to maintain temperature and humidity conditions in the test chamber. Also, the accelerated deterioration test for accelerating deterioration of a sample is conducted by spraying a liquid such as salt water (corrosive liquid) while maintaining conditions for acceleration of deterioration of the sample by introducing outside air (air) and circulating the outside air through the test chamber.

### PRIOR ART

### Patent Document

Patent Document 1: Japanese Patent Laid-Open Publication No. JP 2018-132385

### SUMMARY OF THE INVENTION

### Problems to Be Solved by the Invention

However, in the combination cycle tester stated in the aforementioned Japanese Patent Laid-Open Publication No. JP 2018-132385, the air circulated through the test chamber and the corrosive liquid sprayed onto the sample during the accelerated deterioration test are discharged to the outside of the test chamber. Accordingly, since products such as gases, liquids, or precipitates (solids) produced by the deterioration of the sample caused by the corrosion liquid are also discharged to the outside of the test chamber, a deterioration state of the sample during the accelerated deterioration test cannot be acquired based on the products, which are produced by the deterioration of the sample during the accelerated deterioration test. For this reason, the deterioration state of the sample during the accelerated deterioration test cannot be acquired while maintaining conditions for acceleration of deterioration of the sample.

The present invention is intended to solve the above problem, and one object of the present invention is to provide an accelerated deterioration test apparatus, an accelerated-deterioration-test analysis system, and an accelerated deterioration test method capable of acquiring a deterioration state of a sample during an accelerated deterioration test while maintaining conditions for acceleration of deterioration of the sample.

### Means for Solving the Problems

In an accelerated deterioration test apparatus according to a first aspect of the present invention includes a container configured to be able to accommodate a sample as a subject of an accelerated deterioration test for accelerating deterioration of the sample as the test subject by using a deterioration factor for deteriorating the sample; and an introducer/collector connected to the container to introduce a gas or a liquid as the deterioration factor into the container and to collect, during the accelerated deterioration test, a product that appears with the deterioration of the sample.

In an accelerated-deterioration-test analysis system according to a second aspect of the present invention includes a container configured to be able to accommodate a sample as a subject of an accelerated deterioration test for accelerating deterioration of the sample as the test subject by using a deterioration factor for deteriorating the sample; an introducer/collector connected to the container to introduce a gas or a liquid as the deterioration factor into the container and to collect, during the accelerated deterioration test, a product that appears with the deterioration of the sample; and an analyzer for analyzing the product, which is collected by using the introducer/collector.

In an accelerated deterioration test method according to a third aspect of the present invention includes an accelerated deterioration test step of conducting an accelerated deterioration test for accelerating deterioration of a sample as a test subject by introducing a gas or a liquid as a deterioration factor for deteriorating the sample by using an introducer/collector connected to a container for accommodating the sample to introduce the gas or the liquid as the deterioration factor into the container and to collect a product that appears with the deterioration of the sample from the container with the sample being accommodated in a container; and a collection step of collecting the product, which appears with deterioration of the sample, from the container by using the introducer/collector during the accelerated deterioration test.

### Effect of the Invention

In the accelerated deterioration test apparatus according to the first aspect, the accelerated- deterioration-test analysis system according to the second aspect, and the accelerated deterioration test method according to the third aspect of the present invention, an accelerated deterioration test is conducted by introducing a gas or a liquid as a deterioration factor into a container accommodating a sample as a test subject by using an introducer/collector, and a product that appears with deterioration of the sample is collected by using the introducer/collector. Accordingly, since the gas or the liquid as the deterioration factor is introduced into the container by using the introducer/collector during the accelerated deterioration test, it is possible to maintain conditions for acceleration of deterioration of the sample accelerated by the gas or liquid as the deterioration factor. Also, a deterioration state of the sample can be acquired during the accelerated deterioration test by analyzing the product collected by the introducer/collector during the accelerated deterioration test. For these reasons, the deterioration state of the sample during the accelerated deterioration test can be acquired while maintaining conditions for acceleration of deterioration of the sample. In addition, since the product, which appears with deterioration of the sample, is collected during the accelerated deterioration test, it is possible to prevent the product, which appears with deterioration of the sample, from affecting the accelerated deterioration test.

### BRIEF DESCRIPTION OF THE DRAWINGS

FIG. 1 is a schematic diagram entirely showing a configuration of an accelerated-deterioration-test analysis system according to one embodiment of the present invention.

FIG. 2 is a schematic diagram entirely showing a configuration of a test apparatus main body of an accelerated deterioration test apparatus according to the one embodiment of the present invention.

FIG. 3 is a perspective view showing an outer appearance of the accelerated deterioration test apparatus main body.

FIG. 4 is a perspective view showing the accelerated deterioration test apparatus with its door being opened.

FIG. 5 is a perspective view showing the accelerated deterioration test apparatus main body with its container being pulled out.

FIG. 6 is a cross-sectional view of the accelerated deterioration test apparatus main body taken along a line VI-VI in FIG. 3.

FIG. 7 is a view of an outer appearance of a container.

FIG. 8 is a cross-sectional view of the container taken along a line VIII-VIII in FIG. 7.

FIG. 9 is a perspective cross-sectional view of the container taken along the line VIII-VIII in FIG. 7.

FIG. 10 is a cross-sectional view of the container taken along a line X-X in FIG. 7.

FIG. 11 is a partially enlarged view of a peripheral part of containers each of which is shown in FIG. 6.

FIG. 12 is a cross-sectional view of the peripheral part taken along a line XII-XII in FIG. 11.

FIG. 13 is a cross-sectional view of the peripheral part taken along a line XIII-XIII in FIG. 12.

FIG. 14 is a flowchart showing exemplary accelerated deterioration test and exemplary generated gas analysis processing conducted by the accelerated-deterioration-test analysis system according to the one embodiment of the present invention.

FIG. 15 is a schematic diagram entirely showing a configuration of an accelerated-deterioration-test analysis system according to a modified embodiment.

### MODES FOR CARRYING OUT THE INVENTION

Embodiments embodying the present invention will be described with reference to the drawings.

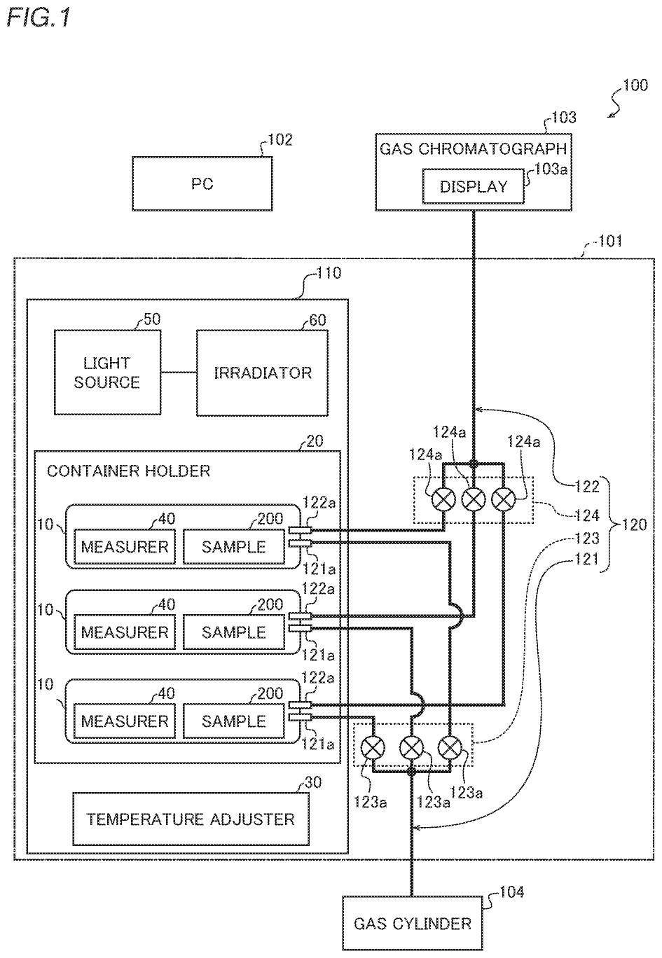

The following description describes a configuration of an accelerated-deterioration-test analysis system 100 and a configuration of an accelerated deterioration test apparatus 101 according to this embodiment with reference to FIGS. 1 to 13.

### Configuration of Accelerated Deterioration Test Apparatus

As shown in FIG. 1, the accelerated-deterioration-test analysis system 100 includes the accelerated deterioration test apparatus 101, a PC (Personal computer) 102, a gas chromatograph 103, and a gas cylinder 104. The PC 102 and the gas chromatograph 103 are an example of a “controller” and an example of an “analyzer, respectively, in the claims. Also, the gas cylinder 104 is an example of a “deterioration factor supply source” in the claims.

The accelerated deterioration test apparatus 101 is an apparatus for conducting an accelerated deterioration test (accelerated aging test) to accelerate deterioration of samples 200. The accelerated deterioration test apparatus 101 is mainly used for material discovery and in prototyping stages in material development. The samples 200 as test subjects to be tested by the accelerated deterioration test apparatus 101 include raw materials (resins, fibers, metals and wood, and the like), paints, components for transportation machines, oil for food, packaging for food, and food.

The accelerated deterioration test apparatus 101 includes a test apparatus main body 110 and an introducer/collector 120. As shown in FIG. 1, the test apparatus main body 110 includes containers 10 that can accommodate the samples 200 as the subjects for the accelerated deterioration test, and a container holder 20 that holds the containers 10. Also, the test apparatus main body 110 is relatively small to be installed in a laboratory.

The test apparatus main body 110 includes a temperature adjuster 30 for adjusting temperature as a deterioration factor, and a measurer 40 for measuring the temperature in the container 10. Also, the test apparatus main body 110 includes a light source 50 for emitting light as a deterioration factor, and an irradiator 60 for irradiating the samples with the light as a deterioration factor emitted from the light source 50.

In this embodiment, the light source 50 is configured to irradiate the samples with light including ultraviolet rays (UV light). The light source 50 includes UV light source for irradiating the samples with ultraviolet rays, for example. The light source 50 may include a xenon light source including a xenon lamp. That is, the light source 50 may be a light source for emitting light that includes a wavelength range other than ultraviolet rays. Also, the light source 50 may be a light source for emitting infrared light.

The PC 102 is configured to control sending of products that appear with the deterioration of the samples 200 to the gas chromatograph 103 through the introducer/collector 120. In this embodiment, the PC 102 controls sending of gases appearing with the deterioration of the samples 200 (generated gases) to the gas chromatograph 103 through the introducer/collector 120. A keyboard, a computer mouse, a display and the like (not shown) are connected to the PC 102.

The gas chromatograph 103 is apparatus for analyzing the products collected by using the introducer/collector 120. The gas chromatograph 103 is configured to analyze the products, which are collected from the containers 10 during the accelerated deterioration test by using the introducer/collector 120, during the accelerated deterioration test. In this embodiment, gas chromatograph 103 analyzes the gases appearing with the deterioration of the samples 200 (generated gases).

In the accelerated-deterioration-test analysis system 100 according to this embodiment, the gas chromatograph 103 includes a display 103a. The display 103a includes a liquid crystal display or an organic EL display. The display 103a may be a touch panel display including a touch panel. In this embodiment, as described above, the generated gases as the products appearing with the deterioration of the samples 200 are analyzed by the gas chromatograph 103. Specifically, the gas chromatograph 103 analyzes the generated gases, which appear with the deterioration of the samples 200 and are sent to the gas chromatograph 103 through the introducer/collector 120. The analysis results of the generated gases analyzed by the gas chromatograph 103 are displayed on the display 103a.

The gas cylinder 104 is filled with an activating gas (gas) as a deterioration factor. The gas cylinder 104 supplies the activating gas into the container 10 through the introducer/collector 120. The activating gas introduced into container 10 includes oxygen, an acid gas, an alkaline gas, or the like, for example. In a case in which oxygen is used as the activating gas, an oxidation resistance test (accelerated deterioration test) for the samples 200 can be conducted. In a case in which the acid gas is used as the activating gas, an acid resistance test (accelerated deterioration test) for the samples 200 can be conducted. In a case in which the alkaline gas is used as the activating gas, an alkaline resistance test (accelerated deterioration test) for the samples 200 can be conducted.

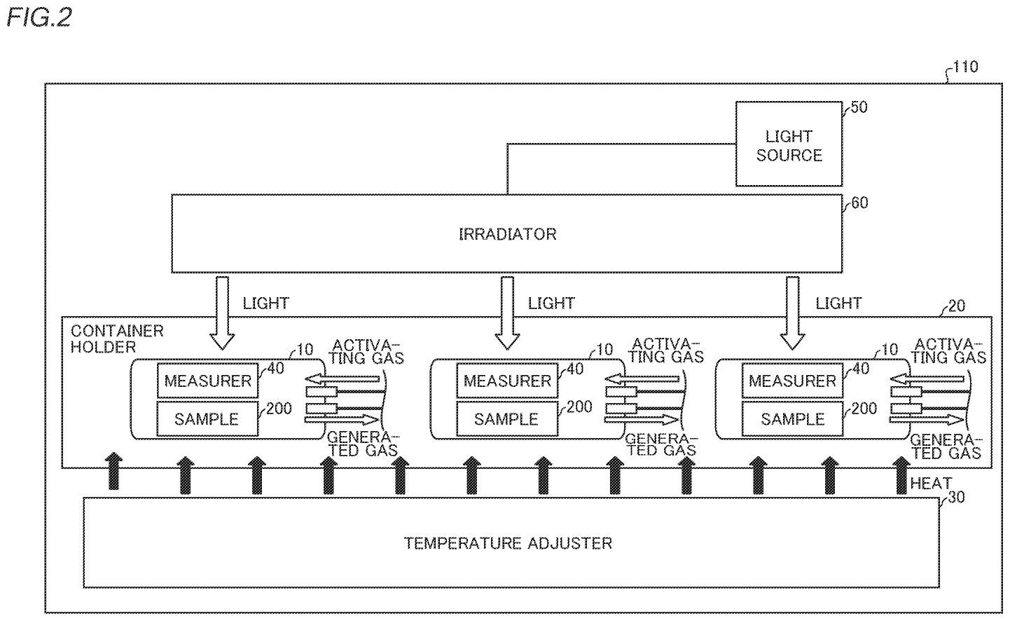

That is, in this embodiment, the test apparatus main body 110 is configured to apply the accelerated deterioration test to the samples 200 accommodated in the containers 10 while introducing the activating gas (gas) as the deterioration factor into the containers 10 accommodating the samples 200. In this embodiment, as shown in FIG. 2, the accelerated deterioration test apparatus 101 introduces the activating gas as the deterioration factor into the containers 10 by using the introducer/collector 120 with the sample 200 being accommodated in the container 10, and accelerates the deterioration of the samples 200 while conducting temperature adjustment and irradiation of the samples 200 with light. Also, the accelerated deterioration test apparatus 101 is configured to collect the products appearing with the deterioration of the samples 200 (generated gases) by using the introducer/collector 120. In other words, the test apparatus main body 110 is a combination accelerated deterioration test apparatus that can conduct an accelerated deterioration test while adjusting a plurality of deterioration factors (applying a plurality of deterioration loads to the samples). Accordingly, it is possible to conduct an accelerated deterioration test (accelerated aging test) under conditions closer to more practical exposure environment (actual exposure environment).

Also, humidity in the container 10 can be adjusted by water contained in the container 10. The humidity in the container 10 can be changed in accordance with an amount of water vapor in the container 10.

Each container 10 is configured to be able to accommodate the sample 200 as the test subject in the accelerated deterioration test for accelerating deterioration of the sample 200 by using the plurality of deterioration factors (activating gas, temperature, light and humidity) for accelerating deterioration of the sample 200. In the test apparatus main body 110, an inert gas such as nitrogen and argon can be introduced into the container 10 instead of the activating gas so that the accelerated deterioration test can be conducted by using at least one of temperature, light and liquid as the deterioration factors (deterioration loads).

In this embodiment, as shown in FIG. 1, the introducer/collector 120 is connected to the containers 10 to introduce the activating gas as the deterioration factor into the containers 10, and to collect the generated gases as the products appearing with the deterioration of the samples 200 during the accelerated deterioration test. The introducer/collector 120 is connected to the gas chromatograph 103 to be able to send the generated gases appearing with the deterioration of the samples 200 to the gas chromatograph 103.

The introducer/collector 120 includes an introduction path 121 connecting the gas cylinder 104 to the containers 10, and a collection path 122 connecting the containers 10 to the gas chromatograph 103. The introduction path 121 is a pipe connecting the gas cylinder 104 to the containers 10. Also, the collection path 122 is a pipe connecting the containers 10 to the gas chromatograph 103.

The introducer/collector 120 includes introduction tubes 121a and collection tubes 122a. Specifically, the introduction path 121 and the collection path 122 include the introduction tubes 121a and the collection tubes 122a, respectively. The introduction tubes 121a and the collection tubes 122a are examples of an “introduction/collection tube” in the claims. The introduction tubes 121a and the collection tubes 122a will be described in detail later.

The introducer/collector 120 includes a switcher 123 for switching selection of, from the plurality of containers 10, the container 10 to which the activating gas as the deterioration factor is introduced. The switcher 123 is an example of a “second switcher” in the claims. The switcher 123 is arranged on the introduction path 121. The switcher 123 includes adjustment valves 123a provided for the plurality of containers 10. In this embodiment, the switcher 123 includes three adjustment valves 123a corresponding to three containers 10. The adjustment valves 123a are provided between introduction tubes 121a and the gas cylinder 104. Flow rates of the activating gas introduced into the containers 10 can be adjusted by adjusting opening degrees of the adjustment valves 123a.

The introducer/collector 120 includes a switcher 124 for switching selection of, from the plurality of containers 10, the container 10 from which the product, which appears with the deterioration of the sample 200, is collected. Here, the switcher 124 is an example of a “first switcher” in the claims. The switcher 124 is arranged on the collection path 122. The switcher 124 includes adjustment valves 124a provided for the plurality of containers 10. In this embodiment, the switcher 124 includes three adjustment valves 124a corresponding to three containers 10. The adjustment valves 124a are provided between the collection tubes 122a and the gas chromatograph 103. Flow rates of the generated gases sent from the container 10 to the gas chromatograph 103 can be adjusted by adjusting opening degrees of the adjustment valves 124a.

The PC 102 controls selection of the container 10 to which the activating gas is introduced by using the switcher 123, and selection of the container 10 from which the generated gas is collected by using the switcher 124. Specifically, the PC 102 controls activation of introduction and deactivation of introduction of the activating gas into the plurality of containers 10 by controlling the opening degrees of the plurality of adjustment valves 123a in the switcher 123, and controls the flow rates of the activating gas introduced into the plurality of containers 10. Also, the PC 102 controls activation of collection and deactivation of collection of gases that include the generated gases from the plurality of containers 10 by controlling the opening degrees of the plurality of adjustment valves 124a in the switcher 124, and controls the flow rates of the gases including the generated gases collected from the plurality of containers 10. The PC 102 controls selection switched by the switcher 123 and the switcher 124 in accordance with timing of activation and deactivation of analysis conducted by the gas chromatograph 103. In addition, pumps may be provided on the introduction path 121 and the collection path 122.

### Configuration of Test Apparatus Main Body

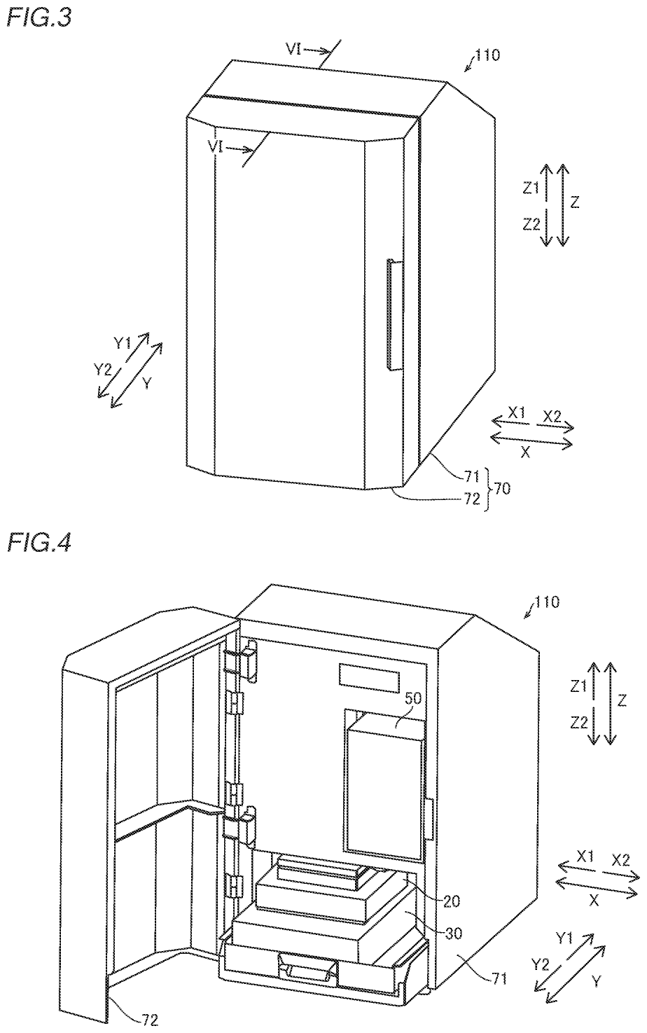

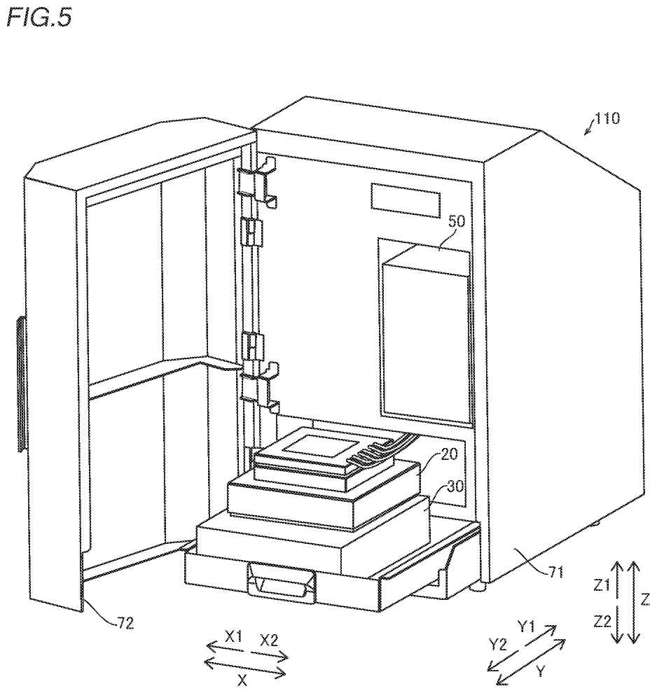

As shown in FIG. 3, the test apparatus main body 110 includes a housing 70 including a main body 71 and an openable/closable door 72 attached to the main body 71. As shown in FIG. 4, the container holder 20, the temperature adjuster 30, and the light source 50 are arranged in the main body 71. Also, as shown in FIG. 5, the test apparatus main body 110 is configured to be able to move (pull out) the container holder 20 and the temperature adjuster 30 to move in a forward direction (Y2 direction) with the door 72 being opened. When the accelerated deterioration test is conducted, the container holder 20 holding the containers 10 accommodating the samples 200 is placed in the main body 71.

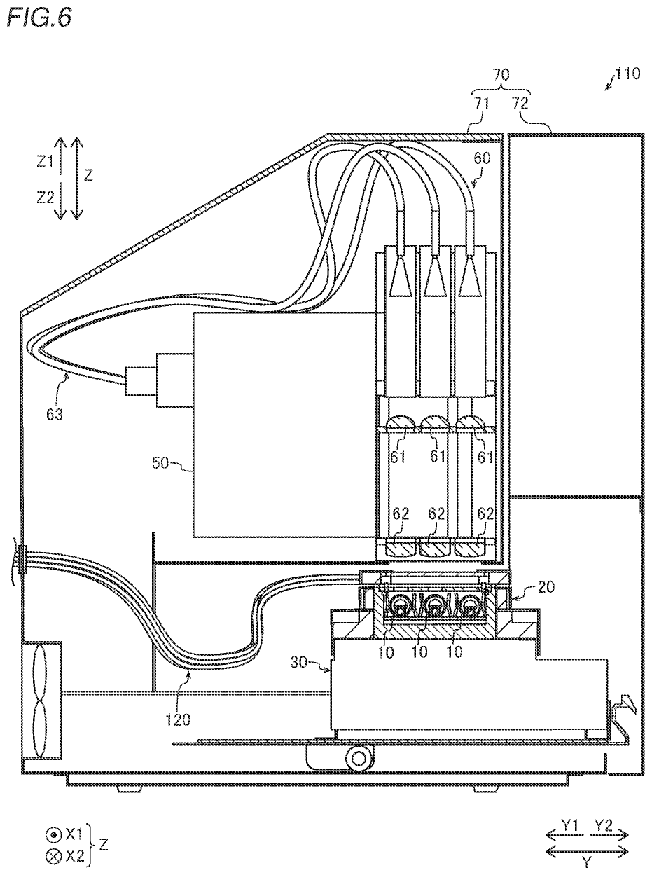

Also, the container holder 20 is interposed between the temperature adjuster 30 and the irradiator 60 in a vertical direction (Z direction) in the main body 71, as shown in FIG. 6. Specifically, the light source 50 and the irradiator 60 are arranged on an upper side (Z1 side) of the container holder 20, and the temperature adjuster 30 is arranged on a lower side (Z2 side) of the container holder 20. The container holder 20 is configured to be arranged on an upper surface of the temperature adjuster 30 in the test apparatus main body 110. The temperature adjuster 30 is configured to increase temperature of air surrounding the containers 10. The temperature adjuster 30 includes a hotplate, for example.

The PC 102 controls adjustment of the temperature by using the temperature adjuster 30, and adjustment of light emitted from the light source 50. For example, a control board is arranged in the housing 70 so that the control board collectively controls adjustment of the temperature by using the temperature adjuster 30, and adjustment of light emitted from the light source 50 based on commands from the PC 102.

Also, the temperature adjuster 30 may be configured to allow a user to make a change of a setting temperature or the like based on operation of the user on an operation unit (not shown). Also, the light source 50 may be configured to allow the user to make a change of intensity of light emitted from the light source or the like based on operation of the user on the operation unit (not shown). In other words, the user may directly control adjustment of the temperature through the temperature adjuster 30, and adjustment of light emitted from the light source 50 (light with which the samples are irradiated by the irradiator 60) without using the PC 102.

As shown in FIG. 6, the containers 10 include a plurality of (three) containers. The irradiator 60 is configured to divert the light emitted from the light source 50, and to irradiate the samples 200, which are accommodated in the plurality of containers 10 held in the container holder 20, with the light.

If the intensity of light emitted by the light source 50 is low, the sample 200 that is located away from a center of an irradiation area cannot be irradiated with sufficient intensity light required for deterioration, and as a result speedup (acceleration) of deterioration due to light may vary depending on a position of the sample in the container 10 in the container holder 20. Contrary to this, in this embodiment, as described above, the irradiator 60 irradiates the samples 200 in the plurality of containers 10 held in the container holder 20 one by one. Accordingly, it is possible to irradiate the samples 200 in the plurality of containers 10 one by one dissimilar to a case in which samples in the plurality of containers 10 are collectively irradiated with light. As a result, even if the intensity of light emitted by the light source 50 is low, it is possible to surely provide a certain amount of intensity of light with which the samples 200 accommodated in the plurality of containers 10 are irradiated independent of the position of the sample in the container 10 in the container holder 20. Consequently, it is possible to reduce variation of speedup (acceleration) of deterioration due to light depending on the position of the sample in the container 10 in the container holder 20.

The irradiator 60 includes lenses 61 and 62. The number of the lenses 61 or 62 is the same as the number of containers 10 that can be held in the container holder 20. In this embodiment, the container holder 20 can hold three containers 10, and three lenses 61 and three lenses 62 are included. Also, the irradiator 60 includes a light guide 63. The light guide 63 includes optical fibers, and is configured to guide the light emitted from the light source 50. The light guide 63 has one end connected to the light source 50, and has three branches on another end. The light emitted from the light source 50 is divided into three light branches by the light guide 63 so that each of the light branches enters corresponding one of a plurality of (three) lenses 62 through corresponding one of a plurality of (three) lenses 61.

### Configuration of Container

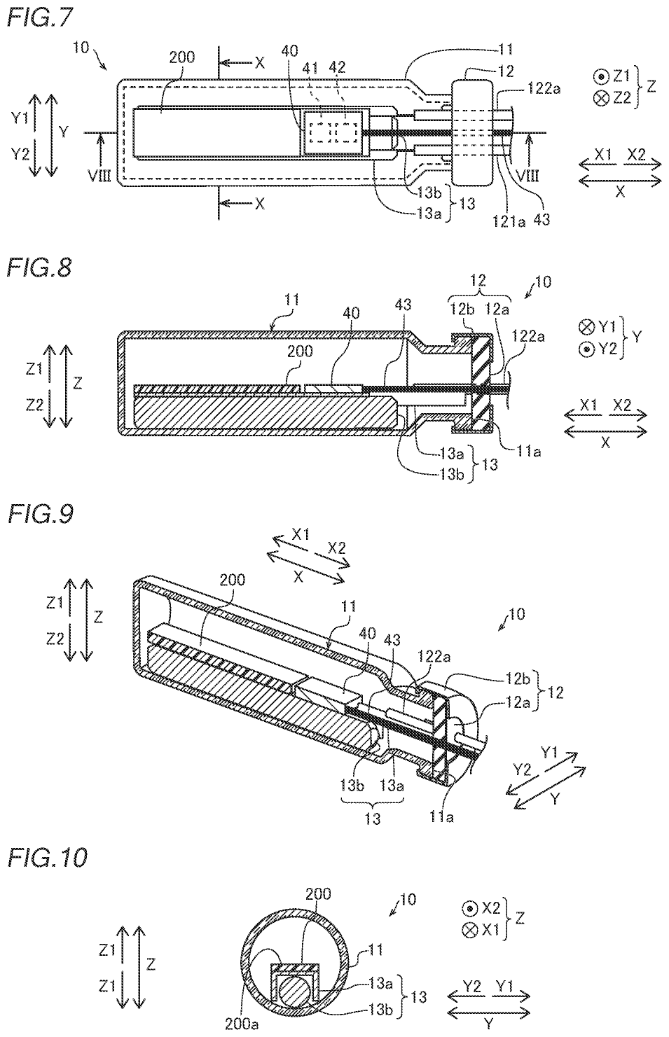

As shown in FIGS. 7 to 10, the container 10 includes a container main body 11 for accommodating the sample 200, and a lid 12 for covering an opening of the container main body 11. The container main body 11 is a transparent part.

The container main body 11 is formed of silica glass or borosilicate glass, for example. Also, the lid 12 is a cap including a septum 12a that can be used for an autosampler. As shown in FIGS. 8 and 9, the lid 12 includes the septum 12a and an aluminum cap 12b, and is configured to cover the opening of the container main body 11. Specifically, the septum 12a is configured to seal the opening 11a of the container main body 11 (an end surface of the container main body 11 on an X2-direction side). The septum 12a includes PTFE (Poly Tetra Fluoro Ethylene), rubber, silicone rubber, polyethylene, or the like, for example. Also, the aluminum cap 12b is configured to cover the septum 12a, which seals the container main body 11 and the opening 11a of the container main body 11, and is configured to tighten the septum 12a and the container main body 11. That is, the aluminum cap 12b is used as an aluminum to-be-crimped part. Also, the aluminum cap 12b is configured to expose a central part of the septum 12a, as shown in FIGS. 8 and 9.

Also, the introduction tube 121a and the collection tube 122a pass through the lid of the container 10 12. Specifically, the introduction tube 121a and the collection tube 122a pass through the central part of the septum 12a exposed from the aluminum cap 12b. In this embodiment, the activating gas is supplied from the gas cylinder 104 through the introduction tube 121a, which passes through the septum 12a. Also, the gas that includes the generated gas appearing with the deterioration of the sample 200 is sent to the gas chromatograph 103 through the collection tube 122a, which passes through the septum 12a. The introduction tube 121a and the collection tube 122a are glass capillaries, for example.

A sample support 13 for supporting the sample 200 in the container 10 is provided (accommodated) in the container 10. The sample support 13 includes a support plate 13a for supporting the sample 200 and a magnetic rod 13b. The magnetic rods 13b is a rod-like ferromagnetic metal part. The magnetic rod 13b is formed of a stainless alloy steel containing chromium (Cr) such as SUS430, for example. Also, the magnetic rod 13b may be plated depending on the activating gas contained in the container 10 and the product appearing with the deterioration of the sample 200 (generated gas).

Also, as shown in FIG. 10, the support plate 13a has a convex U-shaped shape bulging toward a Z1 side (irradiator 60 side) as viewed from an X2-direction side. The support plate 13a is arranged to surround the three directional side (Z1-direction side, Y1-direction side and Y2-direction side) of the magnetic rod 13b, and is configured to hold the magnetic rod 13b.

In this embodiment, the sample support 13 is configured to support the sample 200 in the container 10, and to be able to remove the sample from the container 10. Specifically, the sample support 13 can be removed from the container main body 11 of the container 10 toward the X2-direction side after the lid 12 is removed. Accordingly, since the user can support (place) the sample 200 on the sample support 13 removed from the container 10, the sample 200 can be easily supported on the sample support 13.

### Configuration of Container Holder

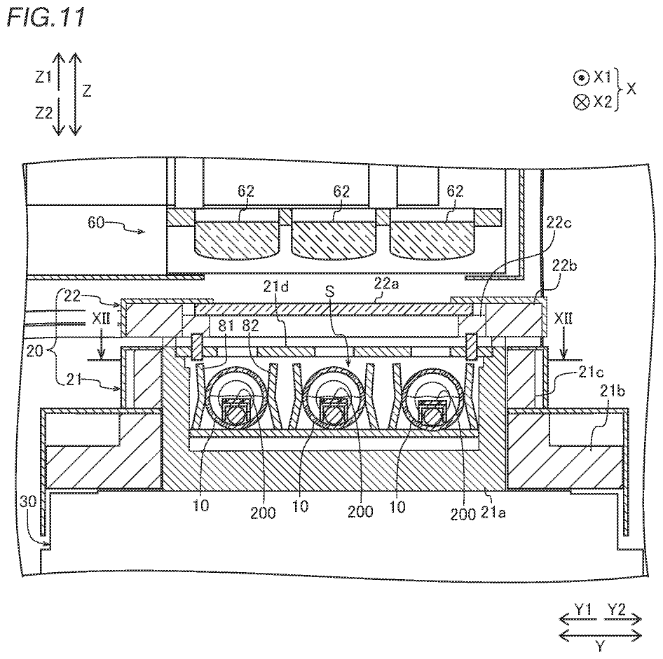

As shown in FIG. 11, the container holder 20 includes an accommodation part 21 for accommodating the containers 10. Also, the container holder 20 includes a cover 22 covering the accommodation part 21 from a top side (Z1-direction side). The accommodation part 21 includes an aluminum block 21a arranged on the upper surface of the temperature adjuster 30. Also, thermally insulating parts 21b and 21c are arranged on an outer periphery of the aluminum block 21a to thermally insulate interior space S defined by the accommodation part 21 and the cover 22. Also, the accommodation part 21 includes a slit plate 21d, which is arranged above the aluminum block 21a and has a plurality of (three) slits corresponding to the plurality of (three) containers 10. Also, the cover 22 includes a quartz plate (silica glass) 22a, which is a plate-like transparent part for allowing light (UV light) with which the sample is irradiated by the irradiator 60 to enter the accommodation part 21. Accordingly, the sample in the interior space S defined by the accommodation part 21 and the cover 22 can be irradiated with the light (UV light) with which the sample is irradiated by the irradiator 60. Also, the cover 22 includes thermally insulating parts 22b and 22c for thermally insulating the interior space S.

The lens 62 of the irradiator 60 is configured to narrow the irradiation area to correspond to a placement position of the sample 200 in the container 10. Specifically, the lens narrows the irradiation area of light guided from the light source 50 into an elongated rectangular irradiation area extending in an X direction to agree a shape of the support plate 13a on which the sample 200 is supported. Accordingly, since the irradiation area is narrowed to agree with the placement position of the sample 200, the sample 200 can be efficiently irradiated with the light. For example, the sample 200 that has a length of ten and several millimeters in the Y direction and a length of several tens millimeters in the X direction can be placed on the support plate 13a.

In this embodiment, the test apparatus main body 110 is configured to apply the accelerated deterioration test to the samples 200 accommodated in the containers 10 by irradiating the sample 200 with the light with which the samples are irradiated through the container main body 11, which is a translucent part, by the irradiator 60, with the samples 200 being accommodated in the containers 10. Specifically, the deterioration of the sample 200 caused by light (UV light) is speeded up (accelerated) by irradiating the sample 200 with the light which is guided from the light source 50 and with which the samples are irradiated through the quartz plate 22a and the container main body 11 by the irradiator 60.

That is, in this embodiment, the test apparatus main body 110 is configured to apply the accelerated deterioration test to the samples 200 accommodated in the containers 10 while adjusting temperature by using the temperature adjuster 30 with the samples 200 being accommodated in the containers 10. Specifically, the temperature adjuster 30 heats air in the interior space S, which is defined by the accommodation part 21 and the cover 22, through the aluminum block 21a of the accommodation part 21 to increase the temperature in the container 10. Accordingly, the deterioration of the sample 200 caused by temperature (heat) is speeded up (accelerated) by increasing temperature in the container 10.

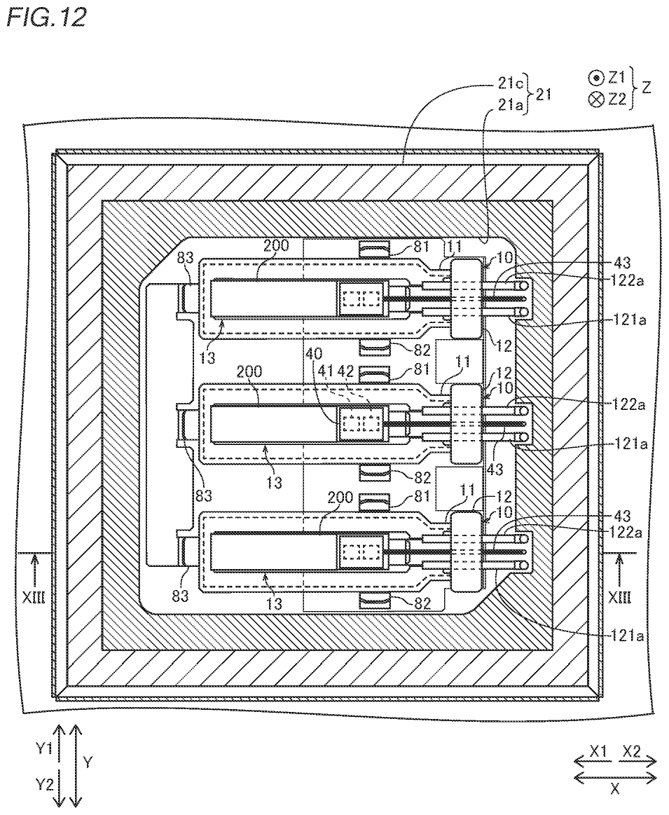

As shown in FIGS. 11 and 12, the container holder 20 holds the plurality of (three) containers 10 accommodating the measurers 40 together with the samples 200.

The measurer 40 includes a temperature sensor 41 accommodated in the container 10, as shown in FIG. 12. In addition, the measurer 40 includes a humidity sensor 42. That is, the measurer 40 can measure temperature and humidity. Here, the temperature sensor 41 and the humidity sensor 42 may be formed integrally with each other. Also, the measurer 40 may include various sensors, such as an illumination sensor, for measuring environments in the container 10. The three containers 10 for accommodating the samples 200 and the measurers 40 are arranged side by side in the Y direction (front-to-rear direction) in the accommodation part 21. The samples 200 accommodated in the three containers 10 may be the same as or different from each other.

Also, the container holder 20 (accommodation part 21) includes removable container stoppers 81, 82 and 83 for removably holding the containers 10. The container stoppers 81, 82 and 83 are configured to be elastically deformed to hold the container 10 from the Y1-direction side, the Y2-direction side, and the X1-direction side. The container stoppers 81, 82 and 83 include plate springs, for example.

Also, the lid 12 of the container 10 accommodating the measurer 40 is configured to allow a communication cable 43 for transmitting detection signals of the measurers 40 (temperature sensor 41 and humidity sensor 42) to the outside to pass through the lid. The communication cable 43 is connected to the control board for controlling the accelerated deterioration test apparatus 101 or the PC 102. Also, the communication cable 43 may be connected to the temperature adjuster 30, the display (not shown) for displaying temperature in the container 10, or the like.

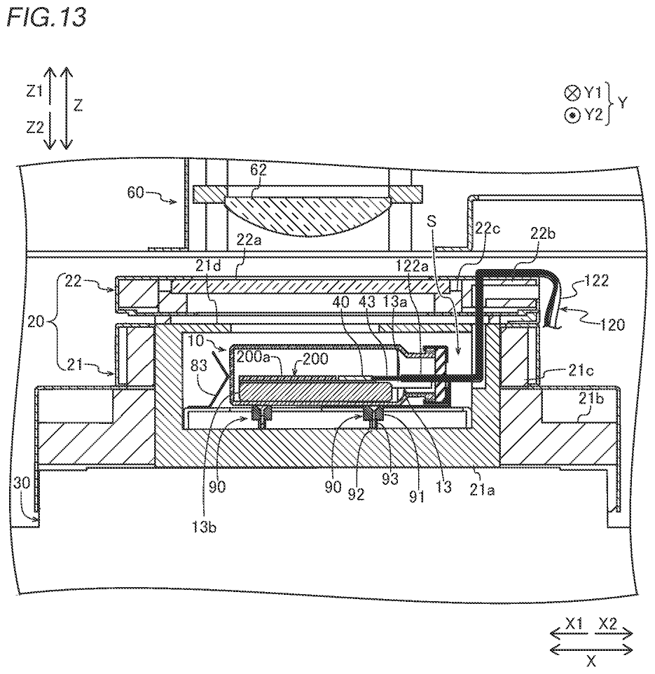

Also, as shown in FIG. 13, the communication cables 43 and the introducer/collectors 120 are arranged to extend from an interior of the container holder 20 to the outside. Also, the container holder 20 includes sample surface adjusters 90 for adjusting inclinations of surfaces 200a of the samples 200 in the containers 10 to angles that bring so that the surfaces 200a of the samples 200 perpendicular to a light irradiation direction (Z direction) of the irradiator 60. Accordingly, since the light can be incident on the surface 200a of the sample 200 in the container 10 perpendicular to the surface of the sample, the deterioration of the sample 200 can be accurately accelerated. Here, the sample surface adjusters 90 are provided to each of the containers 10.

The sample surface adjuster 90 includes a magnet 91 arranged on a side (Z2-direction side) opposite to a side on which the irradiator 60 is arranged with respect to the container 10. Also, the sample surface adjuster 90 includes a screw 92 for attaching the magnet 91 to the aluminum block 21a (accommodation part 21), and a spacer 93 for adjusting a height position (a position in the Z direction) of the magnet 91.

Also, the sample support 13 including the magnetic rod 13b, which is the rod-like ferromagnetic metal part, is configured to be attracted to the magnet 91 to bring the surface 200a of the sample 200 in the container 10 perpendicular to the direction extending in the irradiation direction (Z direction). Specifically, the support plate 13a (see FIG. 10), which holds the magnetic rod 13b and has the U-shape as viewed from the X1-direction side, is adjusted in the container 10 by attracting the magnetic rod 13b to the magnet 91 so that the U-shape bulges toward the Z1-direction side (toward the irradiator 60) as viewed from the X1-direction side. Accordingly, even in a case in which the inclination of the surface 200a of the sample 200 with respect to the irradiation direction is not perpendicular to the irradiation direction of the light with which the sample is irradiated by the irradiator 60 (Z direction) when the sample support 13 holds the container 10, a magnetic force moves the sample support 13, which includes the magnetic rod 13b, to bring the surface 200a of the sample 200 in the container 10 perpendicular to the direction extending in the irradiation direction (Z direction). As a result, since the surface 200a of the sample 200 in the container 10 is brought perpendicular to the direction extending in the irradiation direction (Z direction), the light can be accurately incident on the surface 200a of the sample 200 in the container 10.

### Accelerated Deterioration Test and Analysis Processing of Generated Gases

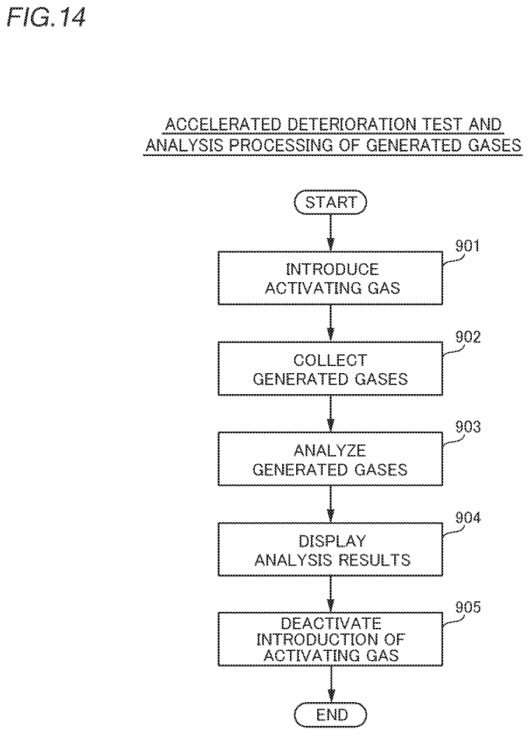

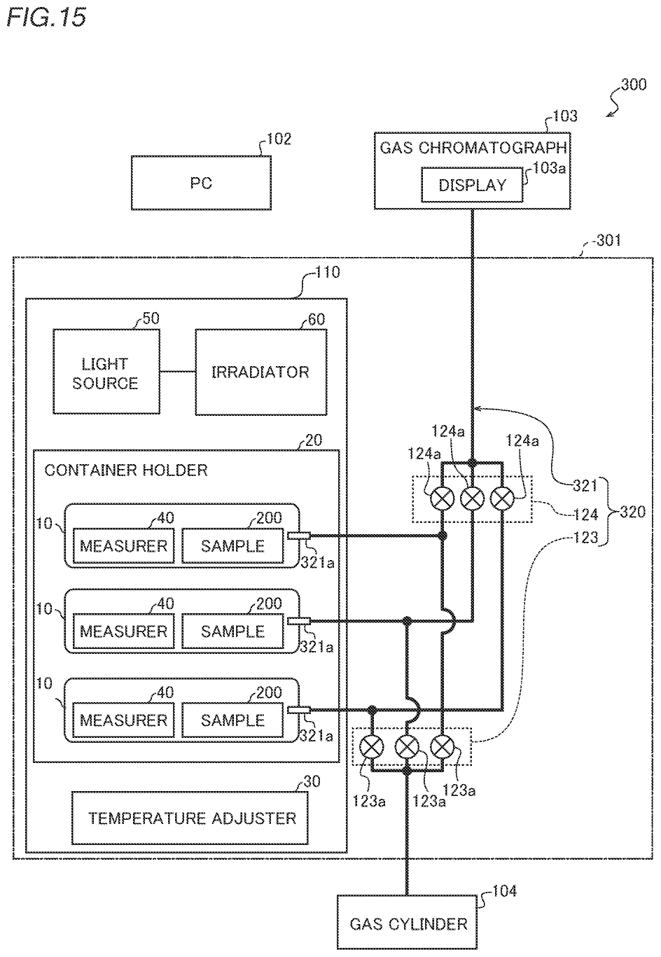

The following description describes a processing flow of the accelerated deterioration test and analysis processing of generated gas conducted by the accelerated-deterioration-test analysis system 100 according to this embodiment with reference to FIG. 14.

In step 901, the activating gas (gas) is first introduced by control of the PC 102. In step 901, the activating gas as the deterioration factor for deteriorating the sample 200 is introduced into the containers 10 by the control of the PC 102 with the samples 200 as the test subject being accommodated in the containers 10. Accordingly, the accelerated deterioration test for accelerating the deterioration of the samples 200 is activated. In step 901, heating by the temperature adjuster 30 and irradiation of the samples with ultraviolet rays (UV light) by the irradiator 60 are activated together with the activation of the introduction of the activating gas (gas) (the activation of the accelerated deterioration test). After step 901 is completed, the procedure goes to step 902. Here, step 901 is an example of a “accelerated deterioration test step” in the claims.

In step 902, collection of the generated gases (products) is conducted by the control of the PC 102. In step 902, the gases appearing with the deterioration of the samples 200 (generated gases) are collected from the containers 10 by the control of the PC 102 during the accelerated deterioration test. After step 902 is completed, the procedure goes to step 903. Here, step 902 is an example of a “collection step” in the claims. Also, step 902 may be executed at any time desired by the user or at a predetermined time after the completion of Step 901 (after the activation of the accelerated deterioration test).

In step 903, the generated gases (products) are analyzed by the gas chromatograph 103. In step 903, the generated gases, which are gases appearing with the deterioration of the samples 200 and are collected from the containers 10 during the accelerated deterioration test, are analyzed during the accelerated deterioration test. In step 903, the gases appearing with the deterioration of the samples 200 (generated gases) are analyzed by the gas chromatograph 103. After analysis in step 903 is completed, the procedure goes to step 904. Here, step 903 is an example of an “analysis step” in the claims.

In step 904, analysis results are displayed on the display 103a. In step 904, the analysis results of the generated gases analyzed by the gas chromatograph 103 are displayed on the display 103a by control of a controller (not shown) of the gas chromatograph 103. Subsequently, if a test time of the accelerated deterioration test reaches the predetermined test time, the procedure goes to step 905.

In step 905, the introduction of the activating gas (gas) is deactivated by the control of the PC 102. In step 905, the control of the PC 102 deactivates the introduction of the activating gas (gas) and ends the accelerated deterioration test. In step 905, heating by the temperature adjuster 30 and irradiation of the samples with ultraviolet rays (UV light) by the irradiator 60 are deactivated together with the deactivation of the introduction of the activating gas (gas).

### Advantages of the Embodiment

In this embodiment, the following advantages are obtained.

In this embodiment, the accelerated-deterioration-test analysis system 100 (accelerated deterioration test apparatus 101) conducts an accelerated deterioration test by introducing an activating gas (gas) as a deterioration factor into containers 10 accommodating samples 200 as test subjects by using an introducer/collector 120, and collects generated gasses (products) that appear with deterioration of the samples 200 by using the introducer/collector 120. Accordingly, since the activating gas as the deterioration factor is introduced into the containers 10 through the introducer/collector 120 during the accelerated deterioration test, it is possible to maintain conditions for acceleration of deterioration of the samples 200 accelerated by the activating gas. Also, deterioration states of the samples 200 can be acquired during the accelerated deterioration test by analyzing the generated gases collected through the introducer/collector 120 during the accelerated deterioration test. For these reasons, the deterioration states of the samples 200 during the accelerated deterioration test can be acquired while maintaining conditions for acceleration of deterioration of the samples 200. In addition, since the generated gases, which appear with deterioration of the samples 200, are collected during the accelerated deterioration test, it is possible to prevent the generated gases, which appear with deterioration of the samples 200, from affecting the accelerated deterioration test.

In addition, following additional advantages can be obtained by the accelerated deterioration test apparatus 101 according to the aforementioned embodiment added with configurations discussed below.

In this embodiment, the containers 10 include container main bodies 11 for accommodating the samples 200, and lids 12 for covering openings of the container main bodies 11. Also, the introducer/collector 120 includes introduction tubes 121a and collection tubes 122a (introduction/collection tubes), which pass through the lids 12 of the containers 10. Accordingly, the activating gas (gas) can be easily introduced through the introduction tubes 121a and the generated gases (products) can be easily collected with the samples 200 being accommodated in the container main bodies 11 (containers 10).

In this embodiment, to introduce the activating gas as the deterioration factor into the containers 10 and to collect the generated gases as the products, which appear with the deterioration of the samples 200 during the accelerated deterioration test, the introducer/collector 120 is connected to the containers 10 and is connected to a gas chromatograph 103 (analyzer) to be able to send the generated gases, which appear with the deterioration of the samples 200, to the gas chromatograph 103. Accordingly, the generated gases, which appear with the deterioration of the samples 200 caused by the activating gas, can be analyzed during the accelerated deterioration test by the gas chromatograph 103. Consequently, it is possible to speedily acquire deterioration states of the samples 200 during the accelerated deterioration test based on analysis results by using the gas chromatograph 103.

In this embodiment, the introducer/collector 120 includes an introduction path 121 connecting a gas cylinder 104, which supplies the activating gas (gas) as the deterioration factor into the containers 10, to the containers 10, and a collection path 122 connecting the containers 10 to the gas chromatograph 103. Accordingly, it is possible to separately and independently conduct introduction of the activating gas (gas) and collection of the generated gases (products) dissimilar to a case in which the path for supplying the activating gas (gas) as the deterioration factor into the containers 10 and the path for connecting the gas chromatograph 103 (analyzer) to the containers 10 are commonly provided. Consequently, it is possible to efficiently introduce the activating gas and efficiently collect the generated gases.

In this embodiment, the introducer/collector 120 includes a switcher 124 (first switcher) for switching selection of, from the plurality of containers 10, the container 10 from which the product, which appears with the deterioration of the sample 200, is collected. Accordingly, it is possible to separately collect the products, which appear with the deterioration of the samples 200 accommodated in the plurality of containers 10, while conducting the accelerated deterioration test of the sample 200 accommodated in the plurality of containers 10 at the same time.

Also, in this embodiment, the introducer/collector 120 includes a switcher 123 (second switcher) for switching selection of, from the plurality of containers 10, the container 10 to which the activating gas (gas) as the deterioration factor is introduced. Accordingly, the supply source of the activating gas (gas cylinder 104) can be commonly provided to the plurality of containers 10. Consequently, it is possible to simplify a configuration of the apparatus by reducing the number of supply sources of the activating gas as compared with a case in which supply sources of the activating gas are separately provided to the plurality of containers 10.

Also, in this embodiment, the accelerated deterioration test apparatus 101 introduces the activating gas (gas) as the deterioration factor into the containers 10 by using the introducer/collector 120 with the samples 200 being accommodated in the containers 10, accelerates the deterioration of the samples 200 while conducting temperature adjustment and irradiation of the samples 200 with light, and collects the products, which appear with the deterioration of the samples 200, by using the introducer/collector 120. Accordingly, it is possible to collect the products, which appear with the deterioration of the samples 200, while accelerating deterioration caused by temperature (heat) of the samples 200 and deterioration of the samples 200 caused by light at the same time in addition to deterioration caused by the activating gas as the deterioration factor.

In addition, following additional advantages can be obtained by the accelerated-deterioration-test analysis system 100 according to the aforementioned embodiment added with configurations discussed below.

In this embodiment, the accelerated-deterioration-test analysis system 100 includes a PC 102 (controller) for controlling sending of generated gases (products) appearing with the deterioration of the samples 200 to the gas chromatograph 103 through the introducer/collector 120. Accordingly, since the generated gases, which appear during the accelerated deterioration test, are sent to the gas chromatograph 103 through the introducer/collector 120 by control of the PC 102, it is possible to automatically analyze the generated gases, which appear during the accelerated deterioration test, by using the gas chromatograph 103. Consequently, it is possible to easily analyze the generated gas by using the gas chromatograph 103 even if the accelerated deterioration test is conducted for a long time as compared with a case in which a user manually controls sending of the generated gases (products) to the gas chromatograph 103.

Also, in this embodiment, the gas chromatograph 103 analyzes the products, which are collected from the containers 10 during the accelerated deterioration test by using the introducer/collector 120, during the accelerated deterioration test. Accordingly, it is possible to analyze reaction that occurs with the deterioration of the samples 200 during the accelerated deterioration test in real time.

Also, in this embodiment, the accelerated-deterioration-test analysis system 100 includes a display 103a for displaying analysis results of the products, which appear with the deterioration of the samples 200 and are sent to the gas chromatograph 103 through the introducer/collector 120, analyzed by the gas chromatograph 103. Accordingly, the user can easily grasp the reaction that occurs with the deterioration of the samples 200 due to the accelerated deterioration test by seeing the analysis results displayed on the display 103a.

### Modified Embodiments

Note that the embodiment disclosed this time must be considered as illustrative in all points and not restrictive. The scope of the present invention is not shown by the above description of the embodiments but by the scope of claims for patent, and all modifications (modified embodiments) within the meaning and scope equivalent to the scope of claims for patent are further included.

While the example in which the accelerated deterioration test apparatus 101 introduces the activating gas as the deterioration factor into the containers 10 by using the introducer/collector 120 with the sample 200 being accommodated in the container 10, and conducts the accelerated deterioration test has been shown in the aforementioned embodiment, the present invention is not limited to this. In the present invention, the accelerated deterioration test apparatus may be configured to introduce a liquid as a deterioration factor into the container by using introducer/collector with the sample being accommodated in the container, and to conduct the accelerated deterioration test. The accelerated deterioration test apparatus may introduce a liquid such as acid liquid, alkaline liquid, salt water, and water into the container, and conduct the accelerated deterioration test. In a case in which an acid liquid is introduced, an acid resistance test of a sample against acids such as acid rain and acidic chemical (accelerated deterioration test) can be conducted. In a case in which an alkaline liquid is introduced, an alkaline resistance test of a sample against alkalis such as alkaline chemicals (accelerated deterioration test) can be conducted. In a case in which salt water is introduced, a resistance test of a sample against seawater and sea breeze can be conducted. In a case in which water is introduced, a water resistance test can be conducted. In the present invention, the accelerated deterioration test apparatus may introduce both a liquid and a gas as deterioration factors and conduct the accelerated deterioration test.

While the example in which gas chromatograph 103 analyzes the generated gas as the product appearing with the deterioration of the sample 200 has been shown in the aforementioned embodiment, the present invention is not limited to this. In the present invention, the analyzer for analyzing the product appearing with the deterioration of the sample is not limited to the gas chromatograph. For example, a liquid or a precipitate may appear as the product with the deterioration of the sample, and be analyzed by a liquid chromatograph or supercritical fluid chromatograph.

While the example in which the accelerated deterioration test apparatus 101 introduces a gas (activating gas) as a deterioration factor into the containers 10 by using the introducer/collector 120 with the sample 200 being accommodated in the container 10, and accelerates the deterioration of the samples 200 while conducting temperature adjustment and irradiation of the samples 200 with light has been shown in the aforementioned embodiment, the present invention is not limited to this. In the present invention, the accelerated deterioration test apparatus may introduce a gas or a liquid as the deterioration factor into the containers by using the introducer/collector with the sample being accommodated in the container, and accelerate the deterioration of the samples 200 while conducting one of temperature adjustment and irradiation of the samples with light. Also, the accelerated deterioration test apparatus may introduce a gas or a liquid into the container by using the introducer/collector only as a deterioration factor with the sample being accommodated in the container to accelerate the deterioration of the sample.

While the example in which the introducer/collector 120 is connected to the gas chromatograph 103 to be able to send the product appearing with the deterioration of the sample 200 to the gas chromatograph 103 (analyzer) for analyzing the product has been shown in the aforementioned embodiment, the present invention is not limited to this. In the present invention, the product collected by using the introducer/collector during the accelerated deterioration test may be collected (stored) in a collection container, and the products collected (stored) in the collection container may be analyzed by an analyzer provided separately from the accelerated deterioration test apparatus during the accelerated deterioration test or after the accelerated deterioration test.

While the example in which the introducer/collector 120 includes an introduction path 121 connecting a gas cylinder 104, which supplies the activating gas (gas) as the deterioration factor into the containers 10, to the containers 10, and a collection path 122 connecting the containers 10 to the gas chromatograph 103 has been shown in the aforementioned embodiment, the present invention is not limited to this. In this invention, as shown in an accelerated-deterioration-test analysis system 300 (accelerated deterioration test apparatus 301) according to a modified embodiment shown in FIG. 15, an introducer/collector 320 uses a common introduction collection path 321 and common introduction/collection tubes 321a for introduction of the gas or the liquid as the deterioration factor and for collection of products.

While the example in which the accelerated deterioration test apparatus 101 includes a plurality of (three) containers 10 has been shown in the aforementioned embodiment, the present invention is not limited to this. In the present invention, the accelerated deterioration test apparatus may include one or two containers, or four or more containers.

While the example in which the introducer/collector 120 includes a switcher 124 (first switcher) for switching selection of, from the plurality of containers 10, the container 10 from which the generated gas as the product, which appears with the deterioration of the sample 200, is collected has been shown in the aforementioned embodiment, the present invention is not limited to this. In the present invention, deterioration factor supply sources for supplying gases or liquids into the containers may be separately provided to the plurality of containers.

While the example in which the introducer/collector 120 includes a switcher 123 (second switcher) for switching selection of, from the plurality of containers 10, the container 10 to which the activating gas (gas) as the deterioration factor is introduced has been shown in the aforementioned embodiment, the present invention is not limited to this. In the present invention, analyzers may be separately provided to the plurality containers.

While the example in which the PC 102 (controller) controls selection of the container 10 to which the activating gas (a gas as the deterioration factor) is introduced by using the switcher 123 (second switcher), and selection of the container 10 from which the generated gas (product) is collected by using the switcher 124 (first switcher) has been shown in this embodiment, the present invention is not limited to this. In the present invention, selection of the container to which the gas or a liquid as the deterioration factor switched by the first switcher, and selection of the container from which the product is collected switched by the second switcher may be conducted based on manual operation of the user.

While the example in which the gas chromatograph 103 (analyzer) of the accelerated-deterioration-test analysis system 100 includes the display 103a for displaying analysis results analyzed by the gas chromatograph 103 has been shown in the aforementioned embodiment, the present invention is not limited to this. In the present invention, the analysis results analyzed by the analyzer may be displayed on a display provided separately from the analyzer. For example, the display connected to the PC 102 (see FIG. 1) may display the analysis results analyzed by the analyzer.

While the example in which, as for the containers 10, the temperature adjuster 30 includes a hot plate and increases temperature of air surrounding the containers 10 has been shown in the aforementioned embodiment, the present invention is not limited to this. In the present invention, the temperature adjuster may be configured to cool air surrounding the containers.

While the example in which the temperature sensor 41 is accommodated in the container 10 has been shown in the aforementioned embodiment, the present invention is not limited to this. In the present invention, the accelerated deterioration test apparatus may measure temperature around the container without the temperature sensor accommodated in the container. Also, the temperature of the sample in the container may be measured by acquiring infrared light emitted from the sample by a sensor outside the container.

While the example in which the irradiator 60 is configured to divert the light emitted from the light source 50, and to irradiate the samples 200, which are accommodated in the plurality of containers 10 held in the container holder 20, with the light has been shown in the aforementioned embodiment, the present invention is not limited to this. In the present invention, the irradiator may collectively irradiate the plurality of containers with light emitted from the light source. Also, the accelerated deterioration test apparatus may include shutters (light shields) in the irradiator or the container holder, and be configured to selectively switch each container whether the container is irradiated with the light.

While the example in which the irradiator 60 is configured including the lens 62 for narrowing the irradiation area to correspond to a placement position of the sample 200 in the container 10 has been shown in the aforementioned embodiment, the present invention is not limited to this. In the present invention, the sample may be irradiated with light without narrowing the irradiation area of light.

While the example in which the sample surface adjuster 90 for adjusting an inclination of the surface 200a of the sample 200 with respect to the irradiation direction is provided has been shown in the aforementioned embodiment, the present invention is not limited to this. In the present invention, no sample surface adjuster may be provided, and the user may adjust the inclination of the surface of the sample with respect to the irradiation direction of light by himself or herself.

While the example in which the sample support 13 including the magnetic rod 13b (rod-like ferromagnetic metal part) is configured to be attracted to the magnet 91 to bring the surface 200a of the sample 200 in the container 10 perpendicular to the direction extending in the irradiation direction (Z direction) has been shown in the aforementioned embodiment, the present invention is not limited to this. In the present invention, a ferromagnetic part may be arranged outside the container 10, and the sample support may include a magnet.

While the example in which the sample support 13 including the magnetic rod 13b (rod-like ferromagnetic metal part) accommodated in the container 10 is configured to be attracted to the magnet 91 to bring the surface 200a of the sample 200 in the container 10 perpendicular to the direction extending in the irradiation direction (Z direction) has been shown in the aforementioned embodiment, the present invention is not limited to this. In the present invention, a ferromagnetic part may be arranged on an exterior wall of the container (container main body).

While the example in which the sample support 13 is configured to support the sample 200 in the container 10, and to be able to remove the sample from the container 10 has been shown in the aforementioned embodiment, the present invention is not limited to this. In the present invention, the sample support may be fixed in the container.

Also, while the example in which the procedure of the accelerated deterioration test and the analysis processing of generated gas according to the present invention has been described by using a flow-driven type flowchart in which processes are sequentially performed along a processing flow for sake of illustration in the aforementioned embodiment, the present invention is not limited to this. In the present invention, procedure operations of the accelerated deterioration test and the analysis processing of generated gas may be realized by an event-driven type processing that executes processes in response to occurrence of events. In this case, the procedure operations of the accelerated deterioration test and the analysis processing of generated gas may be realized entirely by such an event-driven type processing or by a combination of such a flow-driven type processing and such an event-driven type processing.

### MODES

The aforementioned exemplary embodiment will be understood as concrete examples of the following modes by those skilled in the art.

### Mode Item 1

An accelerated deterioration test apparatus includes a container configured to be able to accommodate a sample as a subject of an accelerated deterioration test for accelerating deterioration of the sample as the test subject by using a deterioration factor for deteriorating the sample; and an introducer/collector connected to the container to introduce a gas or a liquid as the deterioration factor into the container and to collect, during the accelerated deterioration test, a product that appears with the deterioration of the sample.

### Mode Item 2

In the accelerated deterioration test apparatus according to mode item 1, the container includes a container main body for accommodating the sample, and a lid for covering an opening of the main body; and the introducer/collector includes an introduction/collection tube passing through the lid of the container.

### Mode Item 3

In the accelerated deterioration test apparatus according to mode item 1 or 2, the introducer/collector is connected to an analyzer for analyzing the product, which appears with the deterioration of the sample, to be able to send the product to the analyzer.

### Mode Item 4

In the accelerated deterioration test apparatus according to mode item 3, the introducer/collector includes an introduction path connecting a deterioration factor supply source for supplying the gas or the liquid as the deterioration factor into the container, and a collection path connecting the container to the analyzer.

### Mode Item 5

In the accelerated deterioration test apparatus according to any of mode items 1 to 4, a plurality of containers are provided as the container; and the introducer/collector includes a first switcher for switching selection of, from the plurality of containers, the container from which the product, which appears with the deterioration of the sample, is collected.

### Mode Item 6

In the accelerated deterioration test apparatus according to any of mode items 1 to 4, a plurality of containers are provided as the container; and the introducer/collector includes a second switcher for switching selection of, from the plurality of containers, the container into which the gas or the liquid as the deterioration factor is introduced.

### Mode Item 7

In the accelerated deterioration test apparatus according to mode item 3 or 4, to introduce an activating gas as the deterioration factor into the container and to collect a generated gas as the product, which appears with the deterioration of the sample, during the accelerated deterioration test, the introducer/collector is connected to the container and is connected to a gas chromatograph as the analyzer to be able to send the generated gas, which appears with the deterioration of the sample, to the gas chromatograph.

### Mode Item 8

In the accelerated deterioration test apparatus according to any of mode items 1 to 7, the accelerated deterioration test apparatus is configured to introduce the gas or the liquid as the deterioration factor into the container by using the introducer/collector with the sample being accommodated in the container, to accelerate the deterioration of the sample while conducting at least one of temperature adjustment and irradiation of the sample with light, and to collect the product, which appears with the deterioration of the sample, by using the introducer/collector.

### Mode Item 9

An accelerated-deterioration-test analysis system includes a container configured to be able to accommodate a sample as a subject of an accelerated deterioration test for accelerating deterioration of the sample as the test subject by using a deterioration factor for deteriorating the sample; an introducer/collector connected to the container to introduce a gas or a liquid as the deterioration factor into the container and to collect, during the accelerated deterioration test, a product that appears with the deterioration of the sample; and an analyzer for analyzing the product, which is collected by using the introducer/collector.

### Mode Item 10

In the accelerated-deterioration-test analysis system according to mode item 9, a controller for controlling sending of the product, which appears with the deterioration of the sample, to the analyzer through the introducer/collector is further provided.

### Mode Item 11

In the accelerated-deterioration-test analysis system according to mode item 10, the analyzer is configured to analyze the product, which is collected from the container during the accelerated deterioration test by using the introducer/collector, during the accelerated deterioration test.

### Mode Item 12

In the accelerated-deterioration-test analysis system according to mode item 10 or 11, a display for displaying an analysis result of the product, which appears with the deterioration of the sample and is sent to the analyzer through the introducer/collector, analyzed by the analyzer is further provided.

### Mode Item 13

An accelerated deterioration test method includes an accelerated deterioration test step of conducting an accelerated deterioration test for accelerating deterioration of a sample as a test subject by introducing a gas or a liquid as a deterioration factor for deteriorating the sample by using an introducer/collector connected to a container for accommodating the sample to introduce the gas or the liquid as the deterioration factor into the container and to collect a product that appears with the deterioration of the sample from the container with the sample being accommodated in a container; and a collection step of collecting the product, which appears with deterioration of the sample, from the container by using the introducer/collector during the accelerated deterioration test.

### Mode Item 14

In the accelerated deterioration test method according to mode item 13, an analysis step of analyzing the product, which appears with deterioration of the sample and is collected from the container during the accelerated deterioration test, during the accelerated deterioration test is further provided.

### Description of Reference Numerals

10; container
11; container main body
12; lid
100, 300; accelerated-deterioration-test analysis system
101, 301; accelerated deterioration test apparatus
102; PC (controller)
103; gas chromatograph (analyzer)
103a; display
104; gas cylinder (deterioration factor supply source)
120, 320; introducer/collector
121; introduction path
121a; introduction tube (introduction/collection tube)
122; collection path
122a; collection tube (introduction/collection tube)
123; switcher (second switcher)
124; switcher (first switcher)
200; sample
321a; introduction/collection tube

1. An accelerated deterioration test apparatus comprising:
a container configured to be able to accommodate a sample as a subject of an accelerated deterioration test for accelerating deterioration of the sample as the test subject by using a deterioration factor for deteriorating the sample; and
an introducer/collector connected to the container to introduce a gas or a liquid as the deterioration factor into the container and to collect, during the accelerated deterioration test, a product that appears with the deterioration of the sample,
wherein the introducer/collector sends the product during the accelerated deterioration test to an analyzer for analyzing the product.

2. The accelerated deterioration test apparatus according to claim 1, wherein
the container includes a container main body for accommodating the sample, and a lid for covering an opening of the main body; and
the introducer/collector includes an introduction/collection tube passing through the lid of the container.

3. The accelerated deterioration test apparatus according to claim 1, wherein the introducer/collector is connected to the analyzer for analyzing the product, which appears with the deterioration of the sample, to be able to send the product to the analyzer.

4. The accelerated deterioration test apparatus according to claim 3, wherein the introducer/collector includes an introduction path connecting a deterioration factor supply source for supplying the gas or the liquid as the deterioration factor into the container, and a collection path connecting the container to the analyzer.

5. The accelerated deterioration test apparatus according to claim 1, wherein
a plurality of containers are provided as the container; and
the introducer/collector includes a first switcher for switching selection of, from the plurality of containers, the container from which the product, which appears with the deterioration of the sample, is collected.

6. The accelerated deterioration test apparatus according to claim 1, wherein
a plurality of containers are provided as the container; and
the introducer/collector includes a second switcher for switching selection of, from the plurality of containers, the container into which the gas or the liquid as the deterioration factor is introduced.

7. The accelerated deterioration test apparatus according to claim 3, wherein to introduce an activating gas as the deterioration factor into the container and to collect a generated gas as the product, which appears with the deterioration of the sample, during the accelerated deterioration test, the introducer/collector is connected to the container and is connected to a gas chromatograph as the analyzer to be able to send the generated gas, which appears with the deterioration of the sample, to the gas chromatograph.

8. The accelerated deterioration test apparatus according to claim 1, wherein the accelerated deterioration test apparatus is configured to introduce the gas or the liquid as the deterioration factor into the container by using the introducer/collector with the sample being accommodated in the container, to accelerate the deterioration of the sample while conducting at least one of temperature adjustment and irradiation of the sample with light, and to collect the product, which appears with the deterioration of the sample, by using the introducer/collector.

9. An accelerated-deterioration-test analysis system comprising:
a container configured to be able to accommodate a sample as a subject of an accelerated deterioration test for accelerating deterioration of the sample as the test subject by using a deterioration factor for deteriorating the sample;
an introducer/collector connected to the container to introduce a gas or a liquid as the deterioration factor into the container and to collect, during the accelerated deterioration test, a product that appears with the deterioration of the sample; and
an analyzer for analyzing the product, which is collected by using the introducer/collector,
wherein the introducer/collector sends the product during the accelerated deterioration test to the analyzer for analyzing the product.

10. The accelerated-deterioration-test analysis system according to claim 9 further comprising a controller for controlling sending of the product, which appears with the deterioration of the sample, to the analyzer through the introducer/collector.

11. The accelerated-deterioration-test analysis system according to claim 10, wherein the analyzer is configured to analyze the product, which is collected from the container during the accelerated deterioration test by using the introducer/collector, during the accelerated deterioration test.

12. The accelerated-deterioration-test analysis system according to claim 10 further comprising a display for displaying an analysis result of the product, which appears with the deterioration of the sample and is sent to the analyzer through the introducer/collector, analyzed by the analyzer.

13. An accelerated deterioration test method comprising:
an accelerated deterioration test step of conducting an accelerated deterioration test for accelerating deterioration of a sample as a test subject by introducing a gas or a liquid as a deterioration factor for deteriorating the sample by using an introducer/collector connected to a container for accommodating the sample to introduce the gas or the liquid as the deterioration factor into the container and to collect a product that appears with the deterioration of the sample from the container with the sample being accommodated in a container; and
a collection step of collecting the product, which appears with deterioration of the sample, from the container by using the introducer/collector during the accelerated deterioration test,
wherein the collection step includes sending the product during the accelerated deterioration test to an analyzer for analyzing the product by using the introducer/collector.

14. The accelerated deterioration test method according to claim 13 further comprising an analysis step of analyzing the product, which appears with deterioration of the sample and is collected from the container during the accelerated deterioration test, during the accelerated deterioration test.
